(19) United States
(12) Patent Application Publication
(10) Pub. No.: US 2010/0218828 A1
(43) Pub. Date: Sep. 2, 2010

(54) Irrigation And Fertigation Collection And Mixing Device, System And Associated Methods

(75) Inventor: Edmund A. Sinda, Bradenton, FL (US)

Correspondence Address: JACQUELINE E. HARTT, PH. D.;LOWNDES DROSDICK DOSTER KANTOR & REED, P.A., P.O. BOX 2809, ORLANDO, FL, 32802-2809, US

(73) Assignee: DEVELOPMENTAL TECHNOLOGIES, LLC, Bradenton, FL (US)

(21) Appl. No.: 12/713,253

(22) Filed: Feb. 26, 2010

Related U.S. Application Data
(60) Provisional application No. 61/156,047, filed on Feb. 27, 2009.

(51) Int. Cl. F16K 31/18

(52) U.S. Cl. 137/3; 137/409

(57) ABSTRACT

A system and a method are provided for maintaining a low-pressure, substantially constant feed of water to an irrigation system. The system utilizes captured rainwater and/or gray water as available. The system can include an element for introducing an additive into the water, such as at least one of water-soluble fertilizer, insecticide, and pest repellent. Preferably the additive is provided so as not to be submerged in the water for maintaining a substantially constant concentration thereof in the water. The system and method are additionally advantageous in that fertigation, extermination, and/or and repelling only occurs when the plants call for water. In use with a typical lawn, the system allows the user to add less fertilizer to the lawn than in prior known systems, thus reducing nutrient (e.g., nitrate), insecticide, and repellant runoff into the aquifer and neighboring bodies of water.

### CROSS-REFERENCE TO RELATED APPLICATION

This application claims priority to provisional patent application Ser. No. 61/156,047, filed Feb. 27, 2009.

### TECHNOLOGICAL FIELD

The technological field generally relates to a device, system, and method for collecting water for use with an irrigation system, and, in particular, to a device, system, and method for collecting water such as rainwater, fresh water, and gray water for use in conjunction with a low-pressure irrigation system for enabling processes such as fertigation, insecticide, and nuisance pest control.

### BACKGROUND

With the advancement of low-pressure irrigation systems designed to develop high water efficiencies, the need for a constant low-pressure supply is amplified. Simple rainwater collection barrels can provide this function, but in times of little or no rainfall, the barrels require manual filling. Over-filling causes an increase in pressure (head pressure due to elevation), which also negatively affects the efficiency of low-pressure irrigation systems. Under-filling can cause a system to become inoperable.

With fresh water becoming more and more scarce, the need for highly efficient irrigation systems is on the rise. The use of collected rainwater and household gray water for irrigation will become a necessity as water becomes more and more scarce. The biggest drawback is that none of the simple collection systems known in the art integrates an automatic system that would allow carefree and fresh water conserving attributes. In addition, as most household irrigation systems are high-pressure fresh water systems, rainwater and gray water collection systems are typically retrofitted and less automated.

A highly efficient irrigation practice comprises a porous membrane operating under low pressure (U.S. Pat. No. 7,198,431). The use of such a membrane preferably entails a low-pressure, constant supply of water. It would be desirable therefore to provide a system and method that provides such a low-pressure, constant supply of water, for example, a supply gleaned from water that would otherwise be diverted into the waste system or from un-captured fresh water that would otherwise be lost to runoff or evaporation.

### SUMMARY

A device, system, and a method are provided for maintaining a low-pressure, substantially constant feed of water to an irrigation system. The instant device, system, and method utilize captured rainwater and/or gray water as available. Fresh water is preferably only utilized when there are insufficient supplies of rainwater and gray water. Overflow means are provided for times of excessive rainwater. The device, system, and method can further comprise means for introducing an additive into the water supply, such as, but not intended to be limited to, at least one of water-soluble fertilizer, insecticide, and pest repellent. Preferably the additive is provided so as not to be submerged in the water for maintaining a substantially constant concentration thereof in the water.

The device, system, and method are additionally advantageous in that fertigation, extermination, and/or and repelling only occurs when the plants call for water. In operation with a typical lawn, the system allows the user to add less fertilizer to the lawn than in prior known systems, thus reducing nutrient (e.g., nitrate), insecticide, and repellant runoff into the aquifer and neighboring bodies of water. Certain concentrations of these chemicals are known to result in fish kills, algal blooms, and contaminated drinking water. The substantially fixed rate of dissolution in the present device, system, and method enables any user, such as a homeowner, to apply precise amounts in specified target areas.

### BRIEF DESCRIPTION OF THE DRAWING

FIG. 1 is a front perspective view of an external tank for use with an irrigation system.

FIG. 2 is a front perspective close-up view of the holding device portion of the tank of FIG. 1, the holding device portion for introducing an additive into system effluent.

### DETAILED DESCRIPTION OF PREFERRED EMBODIMENTS

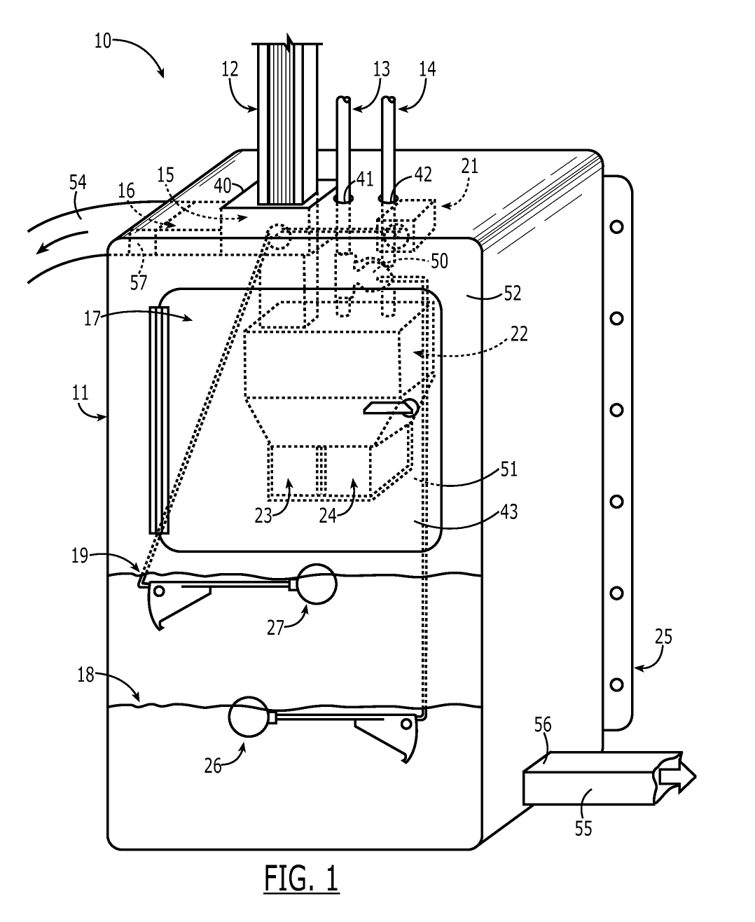

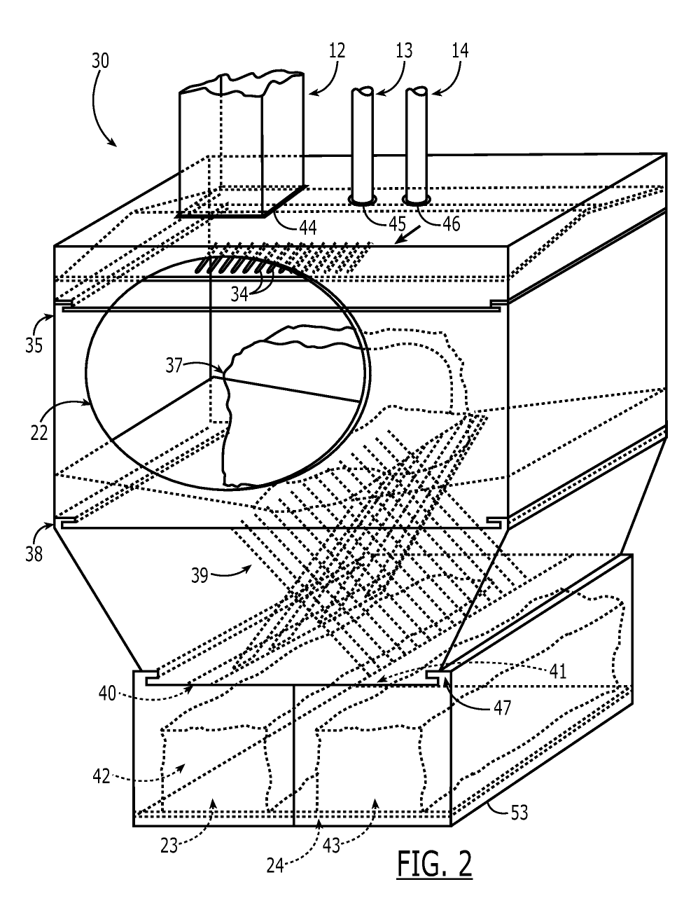

A device, system, and method for low-pressure irrigation and additive introduction will now be presented with reference to FIGS. 1 and 2. One of skill in the art will appreciate that the word “water” used herein is intended to connote an aqueous fluid that can contain impurities and additives therein, and is not intended as a limitation on the invention.

The system and method presented herein, and equivalents thereof, allow for a reduced amount of system water to be maintained through the use of a flow control valve that allows fresh water to be added when required. While the system illustrated and described herein comprises lever arm float balls, one skilled in the art will recognize these could be replaced with substantially any type of float control valve. By means of staggering the heights, and separating the response valves, the system allows for minimum fresh water to be utilized on an “as needed” basis. While not intended as a definition of the limits of the invention, the drawing illustrates the use of two staggered flow control valves (one for fresh water and one controlling rain and gray water simultaneously). One of skill in the art will appreciate the simplicity of staggering an additional float control valve to separate rainwater and gray water control. The position of the staggering controls the “priority” of the addition. Additional float control valves could be added for other water sources as desired.

FIG. 1 illustrates an exemplary device and system 10 comprising an external tank 11. The external tank 11 has apertures 40-42 thereinto for admitting, respectively, a rainwater pipe 12, a fresh water pipe 13, and a gray water pipe 14 into an interior space 43 of the tank 11. A gray water flow control valve is 21 is in fluid communication with the gray water inlet pipe 14. A rainwater diverter valve 15 is in fluid communication with the rain gutter 12 for diverting rainfall in excess of a predetermined volume thereof. When in a diverting position, the rainwater diverter valve 15 channels excess rainfall to an overflow runoff sector 16 within the tank interior space 43, which in turn channels the excess rainwater outside the device 10 through an aperture in the tank wall 52. This excess rainwater can then proceed outside the tank 11, for example, to another downstream portion of the gutter 12. A fresh water shutoff valve 50 is in fluid communication with the fresh water pipe 13.

In the embodiment illustrated, water in the tank 11 can be controlled to a first water level 18 and a higher, second 19 water level. These levels in this embodiment comprise a fresh water controlled level 18 and an “other water” controlled level 19. The device 10 additionally comprises is a fresh water float control 26 positioned within the tank interior space 43 and operative to move the fresh water shutoff valve 50 into a closed position when water in the tank interior space 43 reaches the fresh water controlled level 18. An “other water” float control 27 is positioned within the tank interior space 43 and operative to move the rainwater diverter valve 15 into a diverting position and the gray water flow control valve 21 into a closed position when the water in the tank interior space 43 reaches the “other water” controlled level 19.

The device and system 10 have an access opening 51 through a wall 52 and further comprise an access door 17 from external the tank 11 into the interior space 43. The access door 17 can be sealed, for example, with a gasket, but is preferably positioned above the higher water level 19.

The device and system 10 further comprises a fertigation holding cage 22, below which are positioned an insecticide holding cage 23 and a nuisance pest repellant cage 24. The cages 22-24 are positioned above the second level 19. The fertigation holding cage 22 is in water communication with inlets 12,13,14, and can be positioned therebelow to permit gravity feed, although this is not intended as a limitation.

A bolting side flange 25 can be used for affixing the tank 11 in a desired location; however, one skilled in the art will appreciate that other attachment mechanisms can be contemplated, or an embodiment that is self-supporting.

FIG. 2 illustrates a vessel 30 comprising the fertigation 22, insecticide 23, and nuisance pest repellent 24 holding cages. The fertigation holding cage 22 has inlets 44,45,46, respectively, for receiving water from the rainwater pipe 12 downstream of the diverter valve 15, the fresh water pipe 13, and the gray water pipe 14 downstream of the valve. An angled water drip plate 48, which can in an embodiment have a tented configuration, is positioned within the fertigation cage 22 beneath the inlets 44,45,46, having a plurality of perforations 34 therein. A water-soluble block of fertilizer 37 can be positioned beneath the perforations 34, so that water passing through the plate perforations 34 can impinge thereon. Beneath the fertigation cage 37 is positioned an angled plate 46, which can in an embodiment have an inverted tented configuration, for focusing water therealong to a perforated filter 49. A cut away illustrates how the fertilizer cube 37 is positioned on the angled plate 46. While the present embodiment illustrates the function of holding cages, these are not intended as limitations.

The holding cages 22,23,24 can be assembled, for example, with the use of mating means such as puzzle slides 35,38,47, although this is not intended as a limitation, and one of skill in the art may contemplate other means of affixing the cages 22,23,24 together.

When water exits the fertigation cage 22, having impinged on the fertilization block 37, the water is substantially evenly distributed, for example, by means of cross-angled vanes 39 into the insecticide 23 and pest repellent 24 cages. The water is allowed to pass into the downstream cages 23,24 through slits 40,41 positioned atop of the cages 23,24. An insecticide cube 42 can be positioned within the insecticide cage, and a pest repellent cube 43 can be positioned within the pest repellant cage 24. The mixed water, fertilizer, and at least one of an insecticide and a pest repellent can then exit the cages 23,24 via an outlet aperture that can comprise, for example, an at least partially screened or perforated bottom surface 53. The additive-enhanced water can then proceed to, for example, an irrigation system as desired, via an aperture 56 in the tank 11 that is placeable in fluid communication with a channel 55 leading to an irrigation system.

What is claimed is:

1. An irrigation and additive-introduction device comprising:
a tank having a plurality of apertures into an interior space thereof, including a rain aperture placeable in fluid communication with a source of rainwater, a fresh water aperture placeable in fluid communication with a source of fresh water, a gray water aperture placeable in fluid communication with a source of gray water, and an outlet aperture placeable in fluid communication with an irrigation system;
a gray water control valve placeable in fluid communication with the gray water source, for preventing gray water from entering the tank interior space when in a closed position;
a rainwater diverter valve placeable in fluid communication with the rainwater aperture, for preventing rainwater from entering the tank interior space when in a diverting position;
a fresh water shutoff valve placeable in fluid communication with the fresh water source, for preventing fresh water from entering the tank interior space when in a closed position;
a fresh water float control positioned within the tank at a first level and in controlling relation to the fresh water shutoff valve, for moving the fresh water shutoff valve into the closed position when a level of water within the tank reaches the first level; and
a gray and rainwater float control positioned within the tank at a second level higher than the first level and in controlling relation to the rainwater diverter valve and the gray water control valve, for moving the gray water control valve into the closed position and for moving the rainwater diverter valve into the diverting position when a level of water within the tank reaches the second level.

2. The irrigation and additive-introduction device recited in claim 1, wherein the tank further has an access opening through a wall thereof leading into the interior space from external the tank, and the tank further comprises an openable access door positionable in covering relation to the access opening.

3. The irrigation and additive-introduction device recited in claim 2, wherein the access opening is positioned above the second level.

4. The irrigation and additive-introduction device recited in claim 1, wherein the tank further has an excess rainwater aperture therethrough, and further comprising an overflow runoff sector configured to receive rainwater from the rainwater aperture when the rainwater diverter valve is in the diverting position and to channel the excess rainwater out of the tank via the excess rainwater aperture.

5. The irrigation and additive-introduction device recited in claim 1, further comprising an additive introduction structure positioned within the tank interior space downstream of the rainwater diverter valve, the fresh water shutoff valve, and the gray water control valve, and upstream of the gray and rainwater float controls, the additive introduction structure having apertures positioned to receive water from at least one of the rainwater, fresh water, and gray water sources, and for permitting water to exit therefrom into the tank interior space, the additive introduction structure comprising means for supporting a soluble additive in solid form, wherein, in use, water entering the tank interior space flows past the additive, solubilizes at least a portion of the additive, and flows downward in the tank interior space preparatory to being channeled to an irrigation system.

6. The irrigation and additive-introduction device recited in claim 5, wherein the additive introduction device comprises three additive introduction structures and respective supporting means, one introduction structure and supporting means each for a block of fertilizer, a block of insecticide, and a block of pest repellant.

7. The irrigation and additive-introduction device recited in claim 6, wherein the fertilizer introduction structure and respective supporting means is positioned above the insecticide and pest repellant introduction structures and respective supporting means.

8. The irrigation and additive-introduction device recited in claim 6, further comprising an angled water drip plate positioned above the fertilizer supporting means, the water drip plate having a plurality of perforations therein.

9. The irrigation and additive-introduction device recited in claim 8, wherein the water drip plate has a substantially tented configuration.

10. The irrigation and additive-introduction device recited in claim 6, further comprising an angled plate positioned beneath the fertilizer supporting means and a perforated filter positioned beneath the angled plate and above the respective insecticide and pest repellant supporting means, the angled plate configured for focusing water to the perforated filter.

11. The irrigation and additive-introduction device recited in claim 10, wherein the angled plate has a substantially inverted tented configuration.

12. The irrigation and additive-introduction device recited in claim 6, further comprising a plurality of angled vanes configured to channel water from the fertilizer supporting means to the respective insecticide and pest repellant introduction structures.

13. The irrigation and additive-introduction device recited in claim 5, wherein the exit aperture of the additive introduction structure comprises a bottom surface having a plurality of apertures therethrough.

14. A method for irrigation and introducing an additive into irrigation water comprising:
channeling rainwater, fresh water, and gray water into a tank;
preventing an influx of fresh water into the tank when a level of water in the tank reaches a predetermined first level;
preventing an influx of gray water and rainwater into the tank when a level of water in the tank reaches a predetermined second level higher than the first level; and
channeling water from the tank to an irrigation system

15. The method recited in claim 14, further comprising channeling excess rainwater prevented from entering the tank to an overflow runoff sector and channeling the excess rainwater out of the tank.

16. The method recited in claim 14, further comprising introducing an additive into the water in the tank by flowing water past an additive introduction structure adapted to support a soluble additive in solid form, the additive introduction structure positioned above the second level, wherein, in use, water entering the tank flows past the additive, solubilizes at least a portion of the additive, and flows downward in the tank interior space preparatory to being channeled to an irrigation system.

17. The method recited in claim 16, wherein the additive introduction structure comprises support structures for each of a block of fertilizer, a block of insecticide, and a block of pest repellant.

18. The method recited in claim 17, wherein the fertilizer support structure is positioned above the insecticide and pest repellant support structures.

19. The method recited in claim 17, wherein the additive introducing comprises channeling water onto an angled water drip plate positioned above the fertilizer support structure, the water drip plate having a plurality of perforations therein.

20. The method recited in claim 17, wherein the additive introducing comprises channeling water from the fertilizer support structure to an angled plate and to a perforated filter positioned beneath the angled plate, and thence to the insecticide and pest repellant support structures, the angled plate configured for focusing water to the perforated filter.
